(19) United States
(12) Patent Application Publication
(10) Pub. No.: US 2020/0215562 A1
(43) Pub. Date: Jul. 9, 2020

(54) SPRAY LUBRICATION SYSTEM OF A SHEET PROVIDED WITH ELECTRONICALLY ADJUSTABLE FREQUENCY SPRAYING VALVES

(71) Applicant: DieTronic S.r.l., Sant'Angelo Lodigiano (LO) (IT)

(72) Inventors: Giovanni AMATO, Sant'Angelo Lodigiano (LO) (IT); Rosario LISSANDRELLO, Sant'Angelo Lodigiano (LO) (IT)

(21) Appl. No.: 16/635,574

(22) PCT Filed: Sep. 8, 2017
(86) PCT No.: PCT/IT2017/000189

§ 371 Date: Jan. 31, 2020

(30) Foreign Application Priority Data
Aug. 8, 2017 (IT) 102017000091495

(51) Int. Cl. B05B 12/04; B05B 9/00; B05B 13/02; B21B 45/02

(52) U.S. Cl. CPC B05B 12/04; B21B 45/0251; B05B 13/0228; B05B 9/002

(57) ABSTRACT

A spray lubrication system of sheets is provided with electronically adjustable frequency spraying valves housed at upper and lower spraying heads. Sheets travel between heads on three motorized rolls. The sheet is clamped between rolls and contrast wheels. Sensors monitor and adjust lubricant temperature. A first group of motion sensors detect whether the sheet passes at each spraying valve or not. Using the first sensor group, the system can self-learn the shape of the sheet. A second group of motion sensors at both spraying heads detects whether a lubricant spraying is present at each valve. Using the second sensors, the system can diagnose a malfunction whenever a discrepancy is found between the spraying frequency controlled to a valve and whether a spraying is present at each valve. The upper spraying head is in a box for aspirating the oil mists generated by the lubrication system during the work cycle.

### FIELD OF APPLICATION OF THE INVENTION

The present invention applies to the technical sector of metalworking. More precisely, the present invention relates to a system for spray lubricating sheets (i.e. metal plates) intended to be subjected to technological processes which comprise one or more cold plastic deformations, e.g. made by means of stamping or forging.

### OVERVIEW OF THE BACKGROUND ART

Sheet spray lubrication systems usually comprise a pair of mutually opposite spraying heads for applying lubricant by spraying onto a sheet which is made to transit between them. Each head includes a plurality of spraying valves arranged side-by-side so as to form a row of nozzles generally arranged transversally to the direction by which the sheet is made to advance between the aforesaid heads. An extractor creates a vacuum near the spraying head to aspirate the oil mist which is generated in the immediate proximity of the sheet during its lubrication.

The spray lubrication systems of known type are provided with valves, the spraying frequency of which is adjusted either mechanically or electro-pneumatically. Incidentally, adjusting the spraying frequency of a valve means adjusting the frequency and duration of one or more deliveries of lubricant (i.e. sprayings) by said valve during a work cycle. Since each spraying valve is connected to a conduit or to a tank enclosing pressurized lubricant, the spraying frequency is adjusted by appropriately controlling the opening and closing of the valve.

As mentioned above, the spray lubrication systems of known type are provided with spraying valves, the frequency of which is adjusted either mechanically or electro-pneumatically. This adjustment method however does not allow to control the opening and closing of a valve accurately. In order to avoid spraying less lubricant than desired on a sheet, the valves are thus controlled so as to spray more lubricant than necessary, consequently wasting it. This is an obvious disadvantage of the current spray lubrication systems.

### OBJECTS OF THE INVENTION

It is the object of the present invention to overcome the aforesaid drawback by indicating a spray lubrication system for sheets in which the spraying frequency of the valves can be adjusted with greater accuracy that in the known system of the same type.

### SUMMARY OF THE INVENTION

The present invention relates to a spray lubrication system of at least one sheet comprising:
at least one tank for containing an amount of lubricant;
pumping means of said lubricant from said tank to at least one spraying head;
handling means adapted to make a sheet advance near said head so as to allow a spraying of said lubricant onto said sheet,

wherein, according to the invention, said spraying head comprises one or more valves adapted to spray said lubricant, by means of a respective nozzle, at an electronically adjustable spraying frequency, the lubrication system further comprising:
a control unit connected to said valves to electronically adjust their spraying frequency,
the spraying frequency of each of said valves being adjustable by said control unit independently of the spraying frequency of the other valves of said system,
said control unit being connected also to said pumping means and to said handling means to adjust their operation.

The spraying valves with electronically adjustable (spraying) frequency are known solenoid valves currently used in technical sectors which are very distant from the reference sector of the system of the invention (i.e. the sector of lubrication of sheets intended to undergo one or more cold plastic deformations). More precisely, said valves are, for example, used in endothermic engines to inject determined amounts of appropriately atomized liquid fuel into the cylinders. The spraying valves with electronically adjustable frequency usually comprise a shutter shaped as a conical pin, which is actuated by means of a solenoid which can be electronically controlled by sending electric pulses by a control unit. This ensures much faster reaction times than that of the valves the opening of which is controlled either mechanically or electro-pneumatically. The shorter reaction time advantageously translates into greater accuracy of the spraying frequency adjustment.

By virtue of the very short reaction times of the spraying valves with electronically adjustable frequency, the lubrication system which is the object of the present invention may advantageously operate at lower lubrication pressures with respect to the known systems of the same type. This translates into a tidier distribution of the lubricant on a sheet and consequently in a decrease of the so-called “oil mist” around the lubricant application zone.

The spraying valves with electronic adjustable frequency do not require any manual pre-adjustment of the spraying frequency. This advantageously allows to remotely adjust the amount of lubricant sprayed by the system which is the object of the invention as a function of the viscosity of said lubricant. The benefits in terms of lubrication process repeatability are thus apparent.

As specified above, in the lubrication system which is the object of the invention, the spraying valves, in addition to being electronically adjustable in terms of spraying frequency, can be advantageously controlled by the control unit autonomously from one another, so as to be able to spray lubricant at mutually different frequencies. This makes it possible to lubricate a sheet in part or in sectors (i.e. exclusively in predetermined zones) at its passage at the spraying valves.

Other innovative features of the present invention are illustrated in the description which follows and mentioned in the dependent claims.

According to one aspect of the invention, the lubrication system comprises:
heating means of said lubricant before it is pumped into said spraying head, said control unit being connected to said heating means to adjust their operation;
measuring means of the temperature of said lubricant inside said valves, said measuring means being connected to said control unit to communicate the measured temperature to it,

said heating means being controllable by said control unit so that the temperature measured by said measuring means is as close to a predetermined temperature as possible.

By virtue of the heating and measuring means, the temperature of the lubricant, and consequently its viscosity during a lubrication process of a sheet, can be maintained nearly constant in the system which is the object of the invention. According to another aspect of the invention, the lubrication system comprises:
for each of said valves, first detecting means of a lubricant spraying by said valve, said first detecting means being connected to said control unit to communicate to it whether lubricant spraying at said valve is present or not;
signaling means of a malfunction whenever said control unit detects a discrepancy between the spraying frequency controlled by one of said valves and whether a lubricant spraying is present or not at said valve.

The first detecting means, jointly with the signaling means, advantageously make it possible to monitor the correct operation of the system which is the object of the invention in terms of lubricant spraying. By virtue of said means, in case of malfunctioning, an operator may intervene immediately to repair a possible fault and correct the lubrication of the sheets which is the object of the spraying in the instant in which the signaling means have issued the malfunctioning signal.

For each valve of the system which is the object of the invention, the first detecting means preferably comprise a motion sensor installed at the spraying nozzle of the valve.

According to another aspect of the invention, the lubrication system comprises:
pneumophorous means capable to create a vacuum near the spraying nozzle of one or more of said valves, said pneumophorous means including at least two suction mouths lying on opposite sides with respect to said nozzle, said control unit being connected to said pneumophorous means to adjust the operation thereof.

The presence of two suction mouths in the immediate proximity of the spraying cone of a valve optimizes the extraction of oil mist around the lubrication application zone. This advantageously prevents the accumulation of lubricant particles on the walls of the system which is the object of the invention, particles which could cause undesired dripping on a sheet to be lubricated.

According to another aspect of the invention, the lubrication system comprises:
second means for detecting whether a sheet passes or not at each of said valves when said handling means make a sheet advance near said head so as to allow a spray of said lubricant on said sheet by one or more of said valves, said second detecting means being connected to said control unit to communicate to the latter whether a sheet passes or not at each of said valves.

When the handling means make a sheet advance near the spraying head, the second detecting means, by detecting whether a sheet passes at each valve or not, advantageously allow the control unit to learn both the shape of the sheet and at which valves the sheet is transiting. The system which is the object of the invention can thus autonomously learn the shape of the sheet which is the object of lubrication.

The second detecting means preferably comprise a plurality of motion sensors installed in front of the spraying valves, so as to detect the passage of a sheet before it reaches said valves for a spraying of lubricant.

According to another aspect of the invention, the handling means comprise:
at least one motorized roll;
at least one motorized radial expansion shaft opposite to said roll;
a plurality of contrast wheels coaxial to said shaft, rotationally coupled to the latter and which can shift longitudinally on said shaft by effect of a radial expansion thereof;
mutual approaching and distancing means between said roll and said shaft for clamping a sheet to be lubricated between said roll and at least one of said contrast wheels,

when a sheet is clamped between said roll and at least one of said contrast wheels, said roll and said shaft being able to rotate in opposite sense about a respective longitudinal axis so as to make said sheet advance near said head to allow a spraying of said lubricant onto said sheet by at least one of said valves, said control unit being connected to said roll, to said shaft and to said approaching and distancing means to adjust the operation thereof.

Since the contrast wheels can translate along the motorized shaft, they can be appropriately positioned by the control unit as a function of the shape of the sheet to be lubricated, shape which is preferably self-learned by the system which is the object of the invention by means of the second detecting means.

### BRIEF DESCRIPTION OF THE FIGURES

Further objects and advantages of the present invention will be apparent from the following detailed description of an example of embodiment of the same and from the accompanying drawings exclusively provided by way of non-limiting example, in which:

FIG. 1 shows a diagrammatic perspective view of a lubrication system according to the present invention;

FIG. 2 shows a schematic and partial straight section of the lubrication system in FIG. 2.

### DETAILED DESCRIPTION OF PREFERRED EMBODIMENTS OF THE INVENTION

Hereinafter in the present description a figure may be illustrated also with reference to elements not expressly indicated therein but indicated on other figures instead. The scale and proportions of the various illustrated elements do not necessarily correspond to the real values.

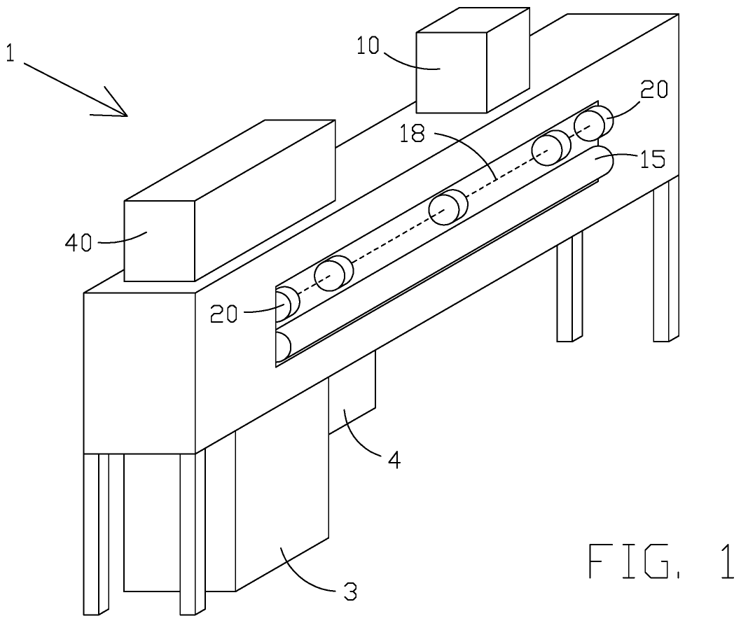

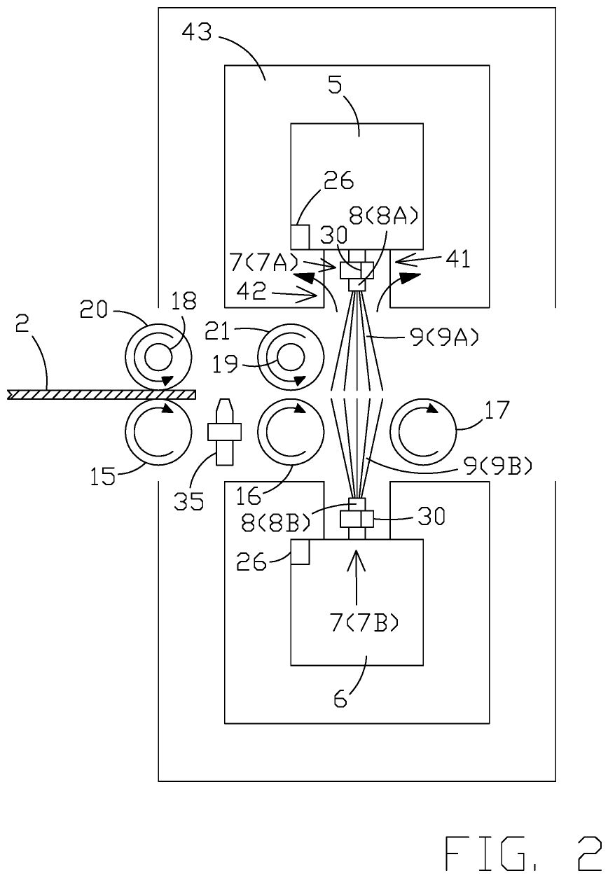

FIGS. 1 and 2 show a spray lubrication system 1 for a sheet 2 intended to undergo technological processes which comprise one or more cold plastic deformations.

The system 1 comprises a tank 3 adapted to contain an amount of lubricant to be sprayed onto the sheet 2, and a pump 4, preferably hydraulic, for transferring the lubricant from the tank 3 to a pair of spraying heads 5 and 6. The latter are preferably arranged on top of each other and include a plurality of valves 7 connected to the pump 4 to receive the pressurized lubricant from the tank 3. Each valve 7 is provided with a nozzle 8 for delivering oil spray. The valves 7 are thus adapted to spray lubricant outside the heads 5 and 6 by means of the nozzles 8. The valves 7 are preferably arranged, in each head 5 or 6, so that the respective nozzles 8 are aligned. More preferably, the nozzles 8A of the valves 7A included in the head 5 are aligned along a direction parallel to that of alignment of the nozzles 8B of the valves 7B included in the head 6. Even more preferably, the nozzles 8A and 8B are aligned horizontally and are arranged so that the respective spraying axis is arranged vertically. Incidentally, when a valve 7 sprays, the lubricant exits from the nozzle 8 creating a spraying cone 9. “Spraying axis” of a nozzle 8 means the longitudinal axis of the spraying cone generated by said nozzle 8. As can be seen in FIG. 2, since the heads 5 and 6 are preferably arranged on top of each other, the valves 7A generate a spraying cone 9A directed preferably downwards and the valves 7B generate a spraying cone 9B preferably directed upwards. The heads 5 and 6 preferably include the same number of valves 7 and the latter are preferably arranged so that a nozzle 8B of the head 6 is opposite to each nozzle 8A of the head 5, and more preferably so that the spraying axes of each pair of reciprocally opposite nozzles 8A and 8B coincide.

The valves 7 are of the electronic adjustable spraying frequency type. They preferably comprise a conical needle shutter so that it is actuated by means of a solenoid which can be electronically controlled by sending electric pulses by a control unit 10, which also belongs to the system 1. The unit 10 is thus connected to the solenoid of each valve 7 and by means of it controls the actuation of the conical needle. This allows the unit 10 to electronically adjust the spraying frequency of the valves 7. More precisely, the unit 10 is preferably configured so that the spraying frequency of each valve 7 is adjustable independently from the spraying frequency of the other valves 7. The unit 10 is thus preferably used to control the valves 7 autonomously from one another. By way of example only, the injectors commercially known today as “CFI-056 Renault Volvo 1.6-2.0” may be used as valves 7.

Incidentally, the unit 10 controls the operation of the valves 7 and also of the pump 4.

In each head 5 and 6, the valves 7 are preferably divided into modules arranged side-by-side. Said modules can be connected and disconnected to and from the pump 4 and the unit 10 an undefined number of times. This confers a preferably modular structure to the heads 5 and 6 which makes it possible to adapt the number of valves 7 present in each head 5 or 6 to the needs of an operator of the system 1. Assuming that each module includes a number of valves 7 preferably equal to four, if said operator needs to arrange a lubrication system, by way of example, with twelve spraying valves in each head, in order to prepare the system 1, it will be sufficient to insert three spraying modules in each head 5 or 6 and to connect them to the pump 4 and to the unit 10.

The system 1 also comprises a sheet handling unit 2 adapted to make the sheet advance between the heads 5 and 6, near them, so as to allow a spraying of lubricant onto the sheet 2 by one or more valves 7. Said handling unit preferably includes three motorized rolls 15, 16 and 17 installed near the head 6, more precisely at the height of the spraying cones 9B. The rolls 15, 16 and 17 are preferably identical to one another and can be rotated, in the same sense, about respective longitudinal axes which are preferably coplanar and reciprocally parallel. More preferably, the rotation axes of the rolls 15, 16 and 17 are parallel to the directions along which the nozzles 8A and 8B are respectively aligned. Even more preferably, the plane on which the rotation axes of the rolls 15, 16 and 17 lie is arranged orthogonally to the spraying axes of the nozzles 8. As can be seen in FIG. 2, the rolls 15 and 16 lie on the opposite part of the spraying cones 8B with respect to the roll 17. The rolls 15, 16 and 17 are preferably coated with rubber.

The sheet 2 is placed on the rolls 15, 16 and 17 at a lower face thereof. The rolls 15, 16 and 17 are controlled by the unit 10 so as to rotate about respective longitudinal axes in a sense such that when the sheet 2 is placed on the rolls 15, 16 and 17, it advances between the heads 5 and 6, so as to be able to receive a spraying of lubricant by one or more valves 7. With reference to the direction of advancement of the sheet 2, the rolls 15 and 16 are in a position before the spraying of the lubricant. The roll 17 is instead in a position successive to said spraying. In other words, in a determined instant of time, the portion of sheet 2 placed on the rolls 15 and 16 has not yet transited between the heads 5 and 6. Incidentally, since the rotation axes of the rolls 15, 16 and 17 are preferably parallel to the directions along which the nozzles 8A and 8B are respectively aligned, said alignment directions are preferably arranged orthogonally to the direction of advancement of the sheet 2. Additionally, since the plane on which the rotation axes of the rolls 15, 16 and 17 lie is arranged orthogonally to the spraying axes of the nozzles 8, when the sheet 2 is made to advance the heads 5 and 6, it is preferably arranged orthogonally to the spraying axes of the nozzles 8.

As previously mentioned, the valves 7 can be controlled by the unit 10 autonomously from one another and may therefore spray lubricant at mutually different frequencies. When the sheet 2 is made to advance by the rolls 15, 16 and 17 between the heads 5 and 6, the sheet 2 can thus be lubricated in sectors, i.e. exclusively in determined zones of it, as a function of the rotation speed of the rolls 15, 16 and 17 and of the spraying frequencies controlled by the unit 10 of the valves 7.

Incidentally, although the spraying cones 9 are shown in the FIG. 2, the valves 7 spray lubricant preferably at the passage of the sheet 2 between the heads 5 and 6, not before.

In addition to the rolls 15, 16 and 17, the handling unit of the sheet 2 preferably comprises a pair of radial expansion motorized shafts 18 and 19. The shafts 18 and 19 are preferably airshafts with key and are installed near the head 5, more precisely at the height of the spraying cones 9A. The shafts 18 and 19 are preferably identical to each other and can be rotated, in the same sense, about respective longitudinal axes which are preferably coplanar and reciprocally parallel. More preferably, the rotation axes of the shafts 18 and 19 are parallel to the directions along which the nozzles 8A and 8B are respectively aligned. Therefore, they are also parallel to the rotation axes of the rolls 15, 16 and 17. Even more preferably, the plane on which the rotation axes of the shafts 18 and 19 lie is arranged orthogonally to the spraying axes of the nozzles 8. As shown in FIG. 2, the shafts 18 and 19 lie on the same part as the spraying cones 8A, coinciding with the part on which the rolls 15 and 16 lie with respect to the spraying cones 8B. Preferably, the shafts 18 and 19 are reciprocally opposite to the rollers 15 and 16, more preferably so that the rotation axis of the shaft 18 lies on the same vertical plane on which the rotation axis of the roll 15 lies, and the rotation axis of the shaft 19 lies on the same vertical plane on which the rotation axes of the roll 16 lies.

The unit 10 is connected to the shafts 18 and 19 so as to be able to control a rotation of them in a sense opposite to that of rotation of the rolls 15, 16 and 17. Two pluralities of contrast wheels 20 and 21 are respectively housed on the shafts 18 and 19 coaxially to the latter. The wheels 20 or 21 are rotationally coupled to the shaft 18 or 19 on which they are housed, so that a rotation of said shaft 18 or 19 about its longitudinal axis determines a rotation of the wheels 20 or 21 in the same sense. The latter can also translate longitudinally on the respective shaft 18 or 19 by effect of a radial expansion thereof which can be controlled by the unit 10. More precisely, the unit 10 is preferably adapted to position the wheels 20 and 21 along the shafts 18 and 19 so that when the sheet 2 rests on the rolls 15 and 16, at least one of the wheels 20 and 21 is superimposed on the sheet 2. Similarly to rolls 15, 16 and 17, the rolls 20 and 21 are preferably coated with rubber.

The handling unit of the sheet 2 also comprises the linear actuators adapted to make the shafts 18 and 19 translate, preferably vertically, either towards or away from the rolls 15 and 16. More precisely, when the sheet 2 rests on the rolls 15 and 16, the aforesaid actuators are suited to move the shafts 18 and 19 towards the rolls 15 and 16 to the point of clamping the sheet 2 between them and one or more wheels 20 and 21 superimposed on the sheet 2.

The unit 10 is adapted to control a rotation of the shafts 18 and 19 in a sense opposite to that in which the rolls 15 and 16 can be rotated and also at a speed such that there is preferably no sliding (only rolling) friction between the sheet 2 and the rolls 15 and 16. The aforesaid clamping thus guarantees an advancement of the sheet 2 between the heads 5 and 6 without undesired movements of the sheet 2 with respect to the rolls 15 and 16. The linear actuators of the handling unit of the sheet 2 can also be controlled by the unit 10.

In brief, for the purposes of clamping the sheet 2 between the rolls 15 and 16 and one or more wheels 20 and 21, the shafts 18 and 19 can be translated preferably vertically by the unit 10 as a function of the thickness of the sheet 2, and the wheels 20 and 21 can be translated longitudinally by the unit 10 on the shafts 18 and 19 as a function of the shape of the sheet 2. As specified above, one or more wheels 20 and 21 can indeed be positioned by the unit 10 on the shafts 18 and 19 so as to be superimposed on the sheet 2, and thus so as to be come into contact with it at an approaching of the shafts 18 and 19 to the rolls 15 and 16 by effect of the aforesaid liner actuators.

The rolls 15, 16 and 17 and the shafts 18 and 19 are preferably arranged so that, when the sheet 2 is clamped between the rolls 15, 16 and the wheels 20, 21, and at a passage of the sheet 2 between a reciprocally opposite valve pair 7A and 7B, the distance between the sheet 2 and the nozzle 8A or 8B of each of said valves 7A and 7B (measured along the spraying axis of said nozzle 8A or 8B) is preferably comprised between 40 mm and 60 mm, and more preferably is 50 mm. The aforesaid distance is lower than the corresponding distance which can be found in the known lubrication systems belonging to the same type as the system 1. This constitutes a considerable advantage with respect to said known systems because in the latter the excessive distance between the spraying nozzles and the sheet to be lubricated causes excessive application of lubricant in a central zone of the intersection between each spraying cone and the sheet and a poor application of lubricant in a peripheral zone of said intersection. In the system 1, the aforesaid distance preferably comprised between 40 mm and 60 mm ensures a uniform application of lubricant on the intersection surface between the sheets 2 and the spraying cones 9. Advantageously, the short distance between the sheet 2 and the nozzles 8 further reduces the generation of oil mist in the application zone of the lubricant.

In light of considerations of exclusively geometric nature, the smaller the distance between the sheets 2 and the nozzles 8, the smaller the intersection area between the sheet 2 and the spraying cones 9. For the aforesaid area, in the system 1, to not be smaller than that of the known lubrication systems, each nozzle 8 is provided with a spraying cap such that the corresponding spraying cone 9 has an amplitude preferably comprised between 50° and 70°, and more preferably is 60°. Said amplitude is higher than the amplitude of the spraying cones of the known lubrication systems and makes it possible to compensate for the smaller extension of the intersection between the sheet 2 and the spraying cones 9 which would be found in the system 1 by effect of the smaller distance between the sheet 2 and the nozzles 8. Incidentally, “amplitude of a spraying cone” means double the amplitude of the angle comprised between a generating line of said cone and its longitudinal axis (i.e. the spraying axis associated with said cone).

In brief, in the system 1, the distance between the sheet 2 and the nozzles 8 and the amplitude of the spraying cones 9 are such that the lubricant can be advantageously sprayed in uniform manner onto the sheet 2 without its application area being smaller than that which can be found in the known lubrication systems.

The valves 7 are housed in the heads 5 and 6 preferably so that the pitch between two consecutive nozzles 8A or 8B is preferably comprised between 40 mm and 60 mm, and more preferably is 50 mm. Incidentally, “pitch” between two consecutive nozzles is the distance between their two spraying axes. By virtue of the aforesaid pitch values, when all the nozzles 8A or 8B of the same head 5 or 6 are spraying lubricant in a determined instant of a work cycle, the entire length of the band of the sheet 2 interposed between the heads 5 and 6 in said instant receives lubricant (i.e. there are no zone of it without lubricant). In an alternative embodiment, the system 1 is free from the rolls 16 and 17 and from the shaft 19.

In another alternative embodiment, the system 1 is free from the head 5 or from the head 6. In this case, the system which is the object of the invention can spray lubricant only at one face of the sheet 2.

The system 1 preferably comprises the heating unit of the lubricant before it is introduced by the pump 4 into the spraying heads 5 and 6. The system 1 further comprises sensors 26 for measuring the temperature of the lubricant inside the valves 7. The heating unit and the temperature sensors 26 are connected to the unit 10. The latter is preferably suited to adjust the operation of the heating unit so that the temperature measured by the sensors 26 is as close to a predetermined temperature as possible. In this manner, the temperature of the lubricant (and thus its viscosity) can be adjusted and maintained nearly constant during the lubrication process of the sheet 2.

The system 1 preferably comprises a first group of motion sensors 30 installed near the head 6. More precisely, the system 1 preferably comprises a sensor 30 installed at each nozzle 8 for detecting a spraying of lubricant by the valve 7 to which said nozzle 8 belongs. The sensors 30 are connected to the unit 10 to communicate to the latter whether a spraying of lubricant is present at each valve 7 or not. The system 1 further comprises a warning device, preferably acoustic or optical, controlled by the unit 10 and adapted to emit a malfunction signal whenever the unit 10 detects a discrepancy between the spraying frequency controlled to a valve 7 and whether a spraying of lubricant is present at said valve 7 or not. In other words, the warning device emits a malfunction signal whenever, in a given instant of a work cycle, a sensor 30 does not detect any spraying at a valve 7 which in that instant should be dispensing lubricant. This makes it possible to monitor the correct operation of the system which is the object of the invention in terms of lubricant spraying.

The system 1 preferably also comprises a second group of motion sensors 35 installed near the head 6. More preferably, the sensors 35 are interposed between the rolls 15 and 16 and are aligned along a direction parallel to which the nozzles 8B are aligned (and consequently preferably parallel to the rotation axes of the rolls 15 and 16). The system 1 preferably comprises one sensor 35 for each nozzle 8B. More preferably, each sensor 35 is aligned with a nozzle 8B along a direction parallel to that of advancement of the sheet 2 between the heads 5 and 6. The sensors 35 are installed so as to be able to detect whether the sheet 2 passes over the nozzles 83 or not (and consequently under the nozzles 8A opposite to it). The sensors 35 are further connected to the unit 10 for communicating to the latter whether the sheet 2 passes or not between each mutually opposite pair of nozzles 8A and 8B. By virtue of the sensors 35, the system 1 can thus automatically learn both the shape of the sheet 2 and at which valves 7 it is transiting. The unit 10 may further autonomously control the positioning of the wheels 20 and 21 along the shafts 18 and 19 as a function of the shape of the sheet 2 self-learned by means of the sensors 35.

The system 1 preferably comprises an extractor 40 suited to create a vacuum near the nozzles 8A by means of a pair of suction mouths 41 and 42 placed at the head 5, extended transversal to the advancement direction of the sheet 2 and lying on opposite parts with respect to the nozzles 8A, near the latter. The mouths 41 and 42 extends preferably for the entire length of the head 5, so as to create a vacuum at each nozzle 8A. More preferably, the mouths 41 and 42 are structured so as to be able to generate suction flows directed substantially orthogonally to the spraying axes of the nozzles 8A. The presence of a pair of mouths 41, 42 and the direction of the suction flows which can be generated by them ensure an optimal extraction of the oil mists about the application zone of the lubricant. The mouths 41 and 42 are preferably made of a suction box 43 (connected to the suction device 40) in which the head 5 is preferably housed. Incidentally, also the extractor 40 is connected to the unit 10, so as to allow the latter to adjust its operation.

In an alternative embodiment of the system 1, the extractor 40 is adapted to create a vacuum also near the nozzles 8B by means of a second pair of suction mouths placed at the head 6, extending transversally to the advancement direction of the sheet 2 and lying on opposite parts with respect to the nozzles 8B, near the latter. Like the mouths 41 and 42, said second suction mouths extend preferably for the entire length of the head 6, so as to create a vacuum at each nozzle 8B. More preferably, said second suction mouths are structured so as to be able to generate suction flows directed substantially orthogonally to the spraying axes of the nozzles 8B.

On the basis of the provided description of a preferred embodiment, it is apparent that changes may be introduced by a person skilled in the art without because of this departing from the scope of the invention as defined by the following claims.

1-10. (canceled)

11. A spray lubrication system (1) for at least one sheet (2), said system (1) comprising:
at least one tank (3) for containing an amount of lubricant;
pumping means (4) of said lubricant from said tank (3) to at least one spraying head (5, 6) comprising one or more valves (7, 7A, 7B) adapted to spray said lubricant, by means of a respective nozzle (8, 8A, 8B), at an electronically adjustable spraying frequency;
handling means (15, 16, 17, 18, 19) adapted to make a sheet (2) advance near said head (5, 6) so as to allow a spraying of said lubricant onto said sheet (2) by said head (5, 6);
a control unit (10) connected to said valves (7, 7A, 7B) to electronically adjust spraying frequency,
said control unit (10) being connected also to said pumping means (4) and to said handling means (15, 16, 17, 18, 19) to adjust their operation,
wherein the spraying frequency of each of said valves (7, 7A, 7B) is adjustable by said control unit (10) independently of the spraying frequency of the other valves (7, 7A, 7B) of said system (1),
said system (1) further comprising:
means (35) for detecting whether a sheet (2) passes or not at each of said valves (7, 7A, 7B) when said handling means (15, 16, 17, 18, 19) make a sheet advance (2) near said head (5, 6) so as to allow a spraying of said lubricant onto said sheet (2) by one or more of said valves (7, 7A, 7B),
said detecting means (35) being connected to said control unit (10) to communicate to the latter whether a sheet (2) passes or not at each of said valves (7, 7A, 7B),
said detecting means (35) comprising at least one motion sensor (35) installed in front of each of said valves (7, 7A, 7B) with respect to the direction of advancement of a sheet (2) by said handling means (15, 16, 17, 18, 19).

12. A system (1) according to claim 11, wherein each of said nozzles (8, 8A, 8B) comprises a spraying cap adapted to generate a spraying cone (9, 9A, 9B) with amplitude comprised between 50° and 70°,
said valves (7, 7A, 7B) being arranged so that, when said handling means (15, 16, 17, 18, 19) make a sheet (2) advance near said head (5, 6) so as to allow a spraying of said lubricant onto said sheet (2) by at least one of said valves (7, 7A, 7B), the distance between the nozzle (8, 8A, 8B) of said valve (7, 7A, 7B) and said sheet (2) is comprised between 40 mm and 60 mm, said distance being measured along the spraying axis of the nozzle (8, 8A, 8B) of said valve (7, 7A, 7B).

13. A system (1) according to claim 11, wherein said valves (7, 7A, 7B) are arranged so that said nozzles (8, 8A, 8B) are aligned at least in part and the pitch between two consecutive nozzles (8, 8A, 8B) is comprised between 40 mm and 60 mm.

14. A system (1) according to claim 11, further comprising:
heating means of said lubricant before the lubricant is pumped into said spraying head (5, 6), said control unit (10) being connected to said heating means to adjust their operation;
measuring means (26) of the temperature of said lubricant inside said valves (7, 7A, 7B), said measuring means (26) being connected to said control unit (10) to communicate the measured temperature to the control unit,
said heating means being controllable by said control unit (10) so that the temperature measured by said measuring means (26) is as close to a predetermined temperature as possible.

15. A system (1) according to claim 11, further comprising:
for each of said valves (7, 7A, 7B), detecting means (30) of a lubricant spraying by said valve (7, 7A, 7B), said detecting means (30) of a lubricant spraying being connected to said control unit (10) to communicate to the control unit whether a lubricant spraying at said valve (7, 7A, 7B) is present or not;
signaling means of a malfunction whenever said control unit (10) detects a discrepancy between the spraying frequency controlled by one of said valves (7, 7A, 7B) and whether a lubricant spraying at said valve (7, 7A, 7B) is present or not.

16. A system (1) according to claim 11, further comprising:
pneumophorous means (40, 41, 42, 43) adapted to create a vacuum near the nozzle (8, 8A, 8B) of one or more of said valves (7, 7A, 7B), said pneumophorous means (40, 41, 42, 43) including at least two suction mouths (41, 42) lying on opposite sides with respect to said nozzle (8, 8A, 8B), said control unit (10) being connected to said pneumophorous means (40, 41, 42, 43) to adjust the operation thereof.

17. A system (1) according to claim 16, wherein said suction mouths (41, 42) are arranged so as to generate aspirating flows directed substantially orthogonally to the spraying axis of said nozzle (7, 7A, 7B).

18. A system (1) according to claim 11, wherein said handling means (15, 16, 17, 18, 19) comprise:
at least one motorized roll (15, 16, 17);
at least one motorized radial expansion shaft (18, 19) opposite to said roll (15, 16, 17);
a plurality of contrast wheels (20, 21) coaxial to said shaft (18, 19), rotationally coupled to the latter and which can shift longitudinally on said shaft (18, 19) by effect of a radial expansion thereof;
mutual approaching and distancing means between said roll (15, 16, 17) and said shaft (18, 19) for clamping a sheet (2) to be lubricated, between said roll (15, 16, 17) and at least one of said contrast rolls (20, 21),
when a sheet (2) is clamped between said roll (15, 16, 17) and at least one of said contrast wheels (20, 21), said roll (15, 16, 17) and said shaft (18, 19) being able to rotate in opposite sense about a respective longitudinal axis so as to make said sheet (2) advance near said head (5, 6) to allow a spraying of said lubricant onto said sheet (2) by at least one of said valves (7, 7A, 7B),
said control unit (10) being connected to said roll (15, 16, 17), to said shaft (18, 19) and to said approaching and distancing means to adjust their operation.

19. A system (1) according to claim 12, wherein said valves (7, 7A, 7B) are arranged so that said nozzles (8, 8A, 8B) are aligned at least in part and the pitch between two consecutive nozzles (8, 8A, 8B) is comprised between 40 mm and 60 mm.
